(19) United States
(12) Patent Application Publication
(10) Pub. No.: US 2016/0034913 A1
(43) Pub. Date: Feb. 4, 2016

(54) SELECTION OF A FRAME FOR AUTHENTICATION

(71) Applicant: Hewlett-Packard Development Company, L.P., Fort Collins, TX (US)

(72) Inventors: Masoud Zavarehi, Corvallis, OR (US); Matthew D. Gaubatz, Seattle, WA (US); Shameed Sait M A, Bangalore (IN)

(21) Appl. No.: 14/447,600

(22) Filed: Jul. 30, 2014

(51) Int. Cl. G06Q 30/00; G06K 7/14

(52) U.S. Cl. CPC G06Q 30/0185; G06K 7/1465

(57) ABSTRACT

Examples disclosed herein provide methods for selecting a frame from a set of frames. One example method includes obtaining a set of frames and, for each frame from the set of frames, determining whether frame meets a quality condition. The example method further includes assigning a quality score for each frame from the set of frames, and selecting a frame from the set of frames, where the selected frame has a higher quality score than other frames from the set of frames.

### BACKGROUND

Brand owners continually deal with the growing threat of product counterfeiting. Attempts have been made to verify product authenticity by incorporating various types of labeling on products. Attempts to stamp out counterfeiting may build trust and loyalty with consumers, and increase profit margins. This may be particularly important for high-volume, high-margin products.

### DRAWINGS

FIG. 1 illustrates a label that may be found on the packaging of a product and used for verifying the authenticity of the product, according to an example;

FIG. 2 illustrates elements of a captured frame of the label of FIG. 1, according to an example;

FIG. 3 illustrates an area of the captured frame of the label of FIG. 1 for calculating a sharpness score, according to an example;

FIG. 4 illustrates elements of the captured frame of the label of FIG. 1 for determining luminous uniformity, according to an example;

FIG. 5 is a block diagram depicting a memory resource and a processing resource, according to an example; and

FIG. 6 is a flow diagram depicting steps to implement an example.

### DETAILED DESCRIPTION

Examples disclosed herein provide a digital authentication solution that allows consumers to verify the authenticity of a product. With the growth of computing devices, such as smartphones, a strong digital authentication solution may be a good complement to physical solutions already existing on the packaging of products, when determining authenticity. The digital authentication solution may enable consumers to verify the authenticity of products with their computing device (e.g., smartphone) via an authentication service.

As an example, at the point of purchase of a product, a consumer may use the camera on theft smartphone to capture a label on the packaging of the product, and send the captured image to the authentication service for verifying the authenticity of the product for copy detection and authentication purposes. The label on the packaging of the product may include authentication features that are used to verify the authenticity of the product via the authentication service. In addition to the authentication features, codes may appear on the label, for example, either as a barcode or in human-readable form. The authentication service may receive the captured label, and determine the authenticity of the product by detecting and identifying copy protection features of the label, such as the authentication features and the code.

One of the general challenges associated with mobile imaging, for example, captured via smartphones, is accounting for the variability in captured frames across a class of devices. As the digital authentication solution described above relies on the capture of the label via the camera on a smartphone, the quality of the captured frame needs to be taken into consideration. Factors affecting the quality of the captured frame include, but are not limited to, the quality of the camera on the smartphone, lighting conditions when capturing the label via the smartphone, and the angle of the smartphone with respect to the label while capturing label.

The quality of the captured frame may play an important role in detecting and identifying the copy protection features of the label, such as the authentication features and the code, via the authentication service. As such, it is necessary that the captured frame meets minimum image quality metric thresholds. The image quality specifications or metrics described below may be used alone or in combination. Examples disclosed herein provide an approach by which a frame is selected that meets such quality conditions or a quality value. Maximizing this quality value when selecting a frame for authenticating a product may reduce the variability in captured frames across a class of devices.

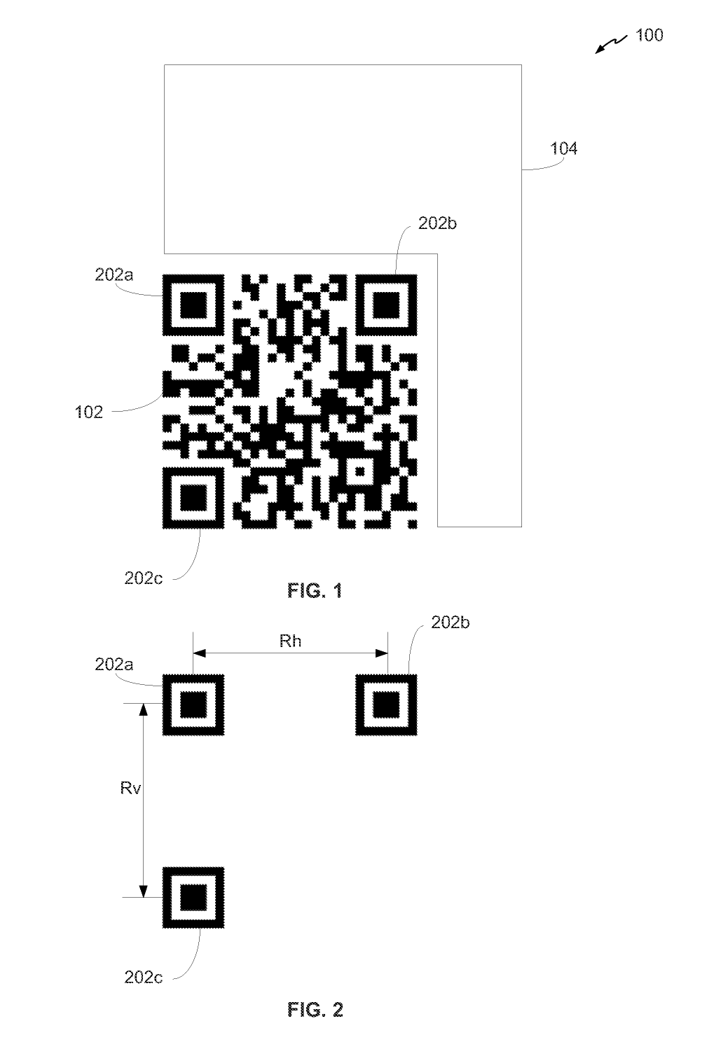

Referring now to the figures, FIG. 1 illustrates a label 100 that may be found on the packaging of a product and used for verifying the authenticity of the product, according to an example. As described above, the authenticity of the product may be determined by using the camera on a computing device, such as a smartphone, to capture the label 100 and upload the captured frame to an authentication service to verify the authenticity of the product. As an example, the label 100 may include graphical content and various copy protection features or authentication features on and around the graphical content.

Referring to FIG. 1, the graphical content may include a barcode, such as a QR code 102. As will be further described, due to the presence of edges, barcodes may offer a number of opportunities for estimating the sharpness of a captured frame. Maximizing this sharpness, in addition to other quality parameters, when selecting a frame for authenticating a product, may reduce the variability in captured frames across a class of devices. For example, selecting a frame in such a manner may include the level of detail for the authentication service to verify authenticity.

Although barcodes, such as the QR code 102 may offer a number of opportunities for estimating the sharpness, the graphical content may not be limited to a barcode. Examples of other graphical content that may be used include designs that are known to include a distribution of bitonal color values (e.g., a region containing pixels that are either a first or a second color, such as black or white). As will be further described, having a graphical content including a distribution of bitonal color values may assist in determining the sharpness of a captured image of the label 100

In addition to the QR code 102, the label 100 may include copy protection features near and/or around the QR code 102 (area for the copy protection features indicated by 104). Examples of such copy protection features include, but are not limited to, multi-color graphics, photo content, and arrays of differently colored squares. For example, the copy protection features can include color tiles, Guilloche curve patterns, and general photographic data. By selecting a captured frame of the label 100 to upload to the authentication service that meets minimum image quality metric thresholds, the captured frame may include the level of detail for the authentication service to verify authenticity.

As will be further described, by selecting the best frame of the label 100 from a set of frames captured over a period of time or a given time interval, the captured frame behavior across various devices may be regularized. As an example, each frame from the set of frames may be assigned an overall estimate of frame quality, based on, for example, targeted estimates of sharpness, coupled with other measurements (e.g., barcode-based size estimates), as will be further described. The image quality specifications or metrics described below may be used alone or in combination when determining an estimate of frame quality and selecting the frame. As an example, the best frame may be selected from a set of frames that, at a minimum, meets one or more of these metrics. However, rather than filtering out frames that do not meet these metrics, the frame having the highest estimate of frame quality from all frames captured may be selected. As an example for determining the estimate of frame quality, each metric may be weighted, where the estimate of frame quality may be a weighted sum of the metrics. The frame with the highest overall estimate of frame quality may be selected for authentication purposes.

A metric for selecting a captured frame of the label 100 may include determining the image resolution of the frame. As an example, the captured frame of the label 100 may require a minimum image resolution, or a minimum width or height of a given object in the captured frame. Selecting a frame that does not meet the minimum image resolution may prevent detectability of certain security features from the captured frame of the label 100 (e.g., copy protection features 104). As an example, the size of the object may be estimated by binarizing the image, and calculating the vertical and horizontal extents of the non-background part of the binarized image. As an example, the size of certain classes of symbols or markings (e.g., 2-D quasi-periodic designs) may be estimated using frequency domain analysis.

FIG. 2 illustrates elements of a captured frame of the label 100 of FIG. 1, according to an example. The elements captured correspond to QR calibration marks 202a-c from the QR code 102, which may be used for determining whether a captured frame meets a specified number of pixels (e.g., the minimum image resolution). The pixels between the two horizontal QR calibration marks 202a-b may be determined (Rh). Similarly, the pixels between the two vertical QR calibration marks 202a, 202c may be determined (Rv). The captured frame may meet the minimum image resolution if the lesser of Rh and Rv is greater than the minimum image resolution (e.g., 120 pixels). If the minimum image resolution is not met, the captured frame may prevent detectability, via the authentication service, of certain security features from the label 100. As an example, another frame meeting the minimum image resolution may be selected.

Another metric for selecting a captured frame of the label 100 may include determining the sharpness of the frame. As an example, for each frame of the label 100 from a set of frames captured over a period of time or a given time interval, a sharpness score may be calculated of an area of the captured frame. By determining whether the sharpness score is above a threshold value, and maximizing the sharpness score by selecting the frame having the higher sharpness score, the variability in captured frames across a class of devices may be reduced. As an example, the area of the captured frame for calculating the sharpness score may include a region containing pixels that are known to have either a first or a second color, such as black or white (e.g., a distribution of bitonal color values). For example, the sharpness score may be calculated for a region with relatively known ratios of dark and light pixels.

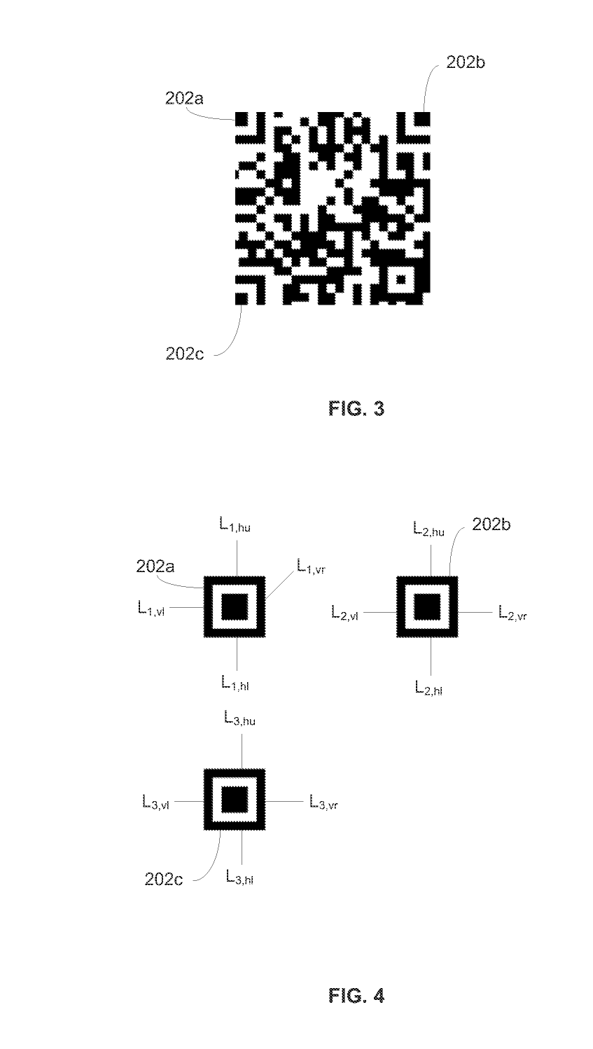

As an example, the QR code 102 of FIG. 1 may include a region with relatively known ratios of pixels that are either black or white. Referring to FIG. 3, the area of the captured frame of label 100 that may be used for calculating the sharpness score may be defined as the area within a rectangle whose three corners are matched with the centroids of the QR calibration marks 202a-c. However, the area of the captured frame of label 100 may not be limited to what is illustrated in FIG. 3. For example, the area may include the whole QR code 102.

Referring to FIG. 3, there are a number of effectively white pixels and a number of effectively black pixels, or a known statistical characteristic between the different colors. Although the QR code 102 of the label 100 affixed on the package of the product may include only black and white pixels, the captured frame of the label, particularly the QR code, may include colors in addition to or besides black and white (e.g., shades of gray). This may be due to the quality of the captured frame. Factors affecting the quality of the captured frame include, but are not limited to, the quality of the camera on the smartphone, lighting conditions when capturing the label via the smartphone, and the angle of the smartphone with respect to the label while capturing label (e.g., producing a blurry image). As a result, the sharpness of such a captured frame may be low. If the sharpness of the QR code of the captured frame is low, it is likely that the sharpness of the copy protection features of the capture frame may also be low, and the authentication service may not be able to verify authenticity. As an example, it may be desirable to select a frame, from the set of frames captured over a period of time, which has a higher sharpness score.

As an example for calculating the sharpness score, for example, of the portion of the QR code illustrated in FIG. 3, color information for each pixel may be sorted from lowest value to highest value. With the distribution of bitonal color values, it is likely that a majority of the color information for the pixels may be at two extremes (e.g., black or white). However, due to quality of the captured frame, some pixels may have different color information besides black or white (e.g., shades of gray). The slope between these two extremes may be indicative of the sharpness of the captured frame. For example, if every pixel is either black or white, the slope between these two extremes may be 90 degrees. However, due to the quality of the captured frame, the slope between these two extremes may be between 0 and 90 degrees. The sharpness score of a captured frame may correspond to this slope, and may be used for rejecting frames that have a sharpness score below a threshold value. As an example, the frame selected from the set of captured frames may have a higher sharpness score than other frames from the set of frames.

Another metric for selecting a captured frame of the label 100 may include determining the luminous intensity from sets of regions within the captured frame. As an example, the metric may be measured from using black pixels from different regions of the captured frame of the label 100. If an average luminous intensity absolute difference from the different regions of the captured frame is above a threshold value (e.g., >10%), there may be lack of uniformity in lighting across the label 100 while it is being captured. As an example, factors affecting the uniformity in lighting of a captured frame of the label 100 may include the angle of lighting on the label 100 and the angle of the smartphone while it is used to capture the frame. It may be desirable to have luminance uniformity across the image, in order for the authentication service to detect copy protection features of the captured frame of the label 100, and verify authenticity.

Referring to FIG. 4, QR calibration marks 202a-c from the QR code 102 of the captured frame may be used for measuring the average luminous intensity absolute difference, according to an example. Specifically, the four black bars around each QR calibration mark may be used for measuring this metric. Each calibration mark (e.g., i=1,2,3) may include a horizontal pair (e.g., L_{i,hu} and L_{i,hl}) and a vertical pair (e.g., L_{i,vl} and L_{i,vr}). The average intensity absolute difference values for each horizontal pair (e.g., dL_{i,h}) and each vertical pair (e.g., dL_{i,v}) of black bars for each of the QR calibration marks may be measured, yielding a total of six values. For example,

dL_{i,v}=abs(L_{i,vl}−L_{i,vr})/min(L_{i,vl}, L_{i,vr}).

Upon measuring the six values, the maximum of the six values may be calculated:

dLₘₐₓ=max(dL_{1,h}, dL_{2,h}, dL_{2,v}, dL_{3,h}, dL_{3,v}).

If the maximum of the average luminous intensity absolute difference for the symbols is less than a threshold value (e.g., 10%), the captured frame may have a sufficient amount of luminous uniformity for the authentication service to detect the copy protection features from the captured frame. However, if dLₘₐₓ is greater than the threshold value, it may be desirable to select another frame for sending to the authentication service.

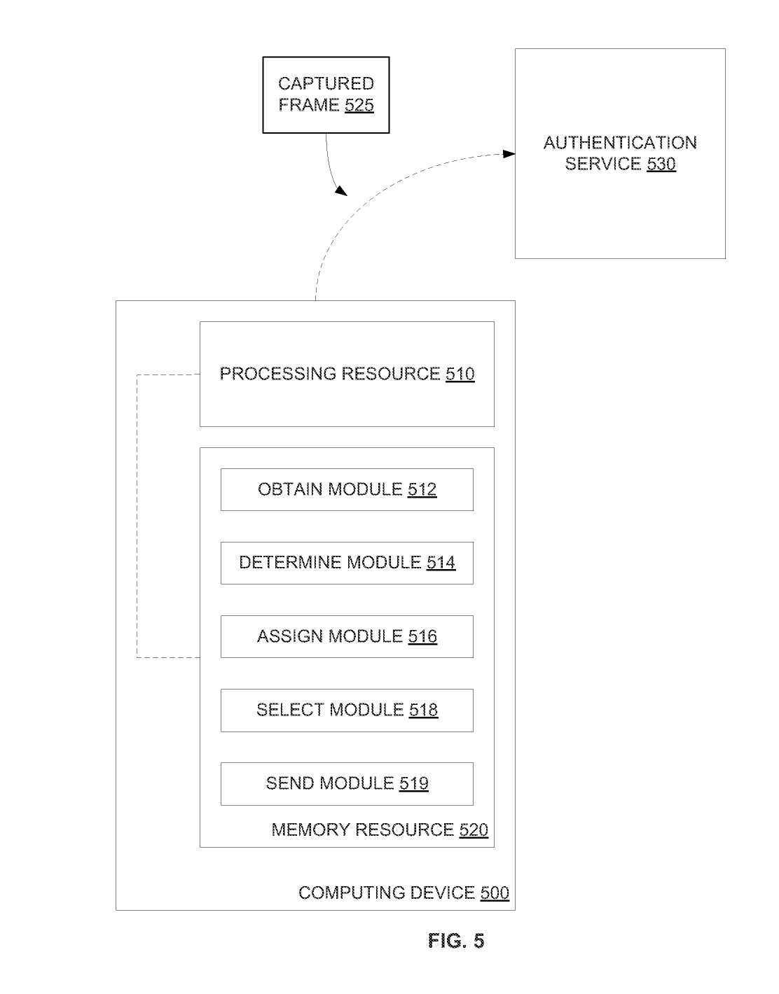

FIG. 5 depicts an example of logical components for implementing various embodiments. As an example, a computing device 500, such as a smartphone, may capture a set of frames of the label 100 of a product (e.g., see FIG. 1), and select the best frame 525 from the set of frames, according to one or more of the metrics described above. Upon selecting the frame 525, the srnartphone 500 may send the frame 525 to an authentication service 530 to determine the authenticity of the product. In examples described herein, the authentication service 530 may be implemented by one or more computing resources (e.g., computing device(s), such as server(s)).

For example, authentication service 530 may comprise any combination of hardware and programming to implement the functionalities of authentication service 530. In examples described herein, such combinations of hardware and programming may be implemented in a number of different ways. For example, the programming may be processor executable instructions stored on at least one non-transitory machine-readable storage medium and the hardware may include at least one processing resource to execute those instructions. In such examples, the machine-readable storage medium may store instructions that, when executed by processing resource(s), implement authentication service 530. In such examples, authentication service 530 may include the machine-readable storage medium storing the instructions and the processing resource(s) to execute the instructions, or the machine-readable storage medium may be separate from but accessible to computing device(s) comprising the processing resource(s) and implementing authentication service 530.

In some examples, the instructions can be part of an installation package that, when installed, can be executed by the processing resource(s) to implement authentication service 530. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on a server including the processing resource. In such examples, the machine-readable storage medium may include memory such as a hard drive, solid state drive, or the like. In other examples, some or all of the functionalities of authentication service 530 may be implemented in the form of electronic circuitry.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In the foregoing discussion, various components of the computing device 500 are identified and refer to a combination of hardware and programming configured to perform a designated function. Looking at FIG. 5, the programming may be processor executable instructions stored on tangible memory resource 520 and the hardware may include processing resource 510 for executing those instructions. Thus, memory resource 520 may store program instructions that, when executed by processing resource 510, implement the various components in the foregoing discussion.

Memory resource 520 may be any of a number of memory components capable of storing instructions that can be executed by processing resource 510. Memory resource 520 may be non-transitory in the sense that it does not encompass a transitory signal but instead is made up of one or more memory components configured to store the relevant instructions. Memory resource 520 may be implemented in a single device or distributed across devices. Likewise, processing resource 510 represents any number of processors capable of executing instructions stored by memory resource 520. Processing resource 510 may be integrated in a single device or distributed across devices. Further, memory resource 520 may be fully or partially integrated in the same device as processing resource 510 (as illustrated), or it may be separate but accessible to that device and processing resource 510. In some examples, memory resource 520 may be a machine-readable storage medium.

In one example, the program instructions can be part of an installation package that when installed can be executed by processing resource 510 to implement the various components of the foregoing discussion. In this case, memory resource 520 may be a portable medium such as a CD, DVD, or flash drive or a memory maintained by a server from which the installation package can be downloaded and installed. In another example, the program instructions may be part of an application or applications already installed. Here, memory resource 520 can include integrated memory such as a hard drive, solid state drive, or the like.

In FIG. 5, the executable program instructions stored in memory resource 520 are depicted as obtain module 512, determine module 514, assign module 516, select module 518, and send module 519. Obtain module 512 represents program instructions that, when executed, cause processing resource 510 to capture and obtain a set of frames of the label 100 (e.g., see FIG. 1), for example, via a camera of the smartphone 500. Determine module 514 represents program instructions that, when executed, cause processing resource 510, for each frame from the set of frames, to determine whether the frame meets a quality condition. As an example, a frame may meet a quality condition by meeting one or more of the metrics described above.

Assign module 516 represents program instructions that, when executed, cause processing resource 510 to assign a quality score for each frame from the set of frames. As an example, the quality score may be based at least upon one or more of the metrics described above. For example, the quality score may be based upon the number of pixels in the frame between symbols, the sharpness score, and the maximum of the average luminous intensity absolute difference for the sets of regions within the frame. As described above, each metric may be weighted, and the quality score may be a weighted sum of the weighted metrics.

Select module 518 represents program instructions that, when executed, cause processing resource 510 to select a frame (e.g., captured frame 525) from the set of frames, which has a higher quality score than other frames from the set of frames. As an example, the frame selected may meet the quality condition described above, by meeting one or more the metrics. However, rather than filtering out frames that do not meet these metrics, the frame having the highest quality score from all frames captured may be selected. Send module 519 represents program instructions that, when executed, cause processing resource 510 to send the captured frame 525 to the authentication service 530 for authenticating the label 100 captured in the selected frame 525.

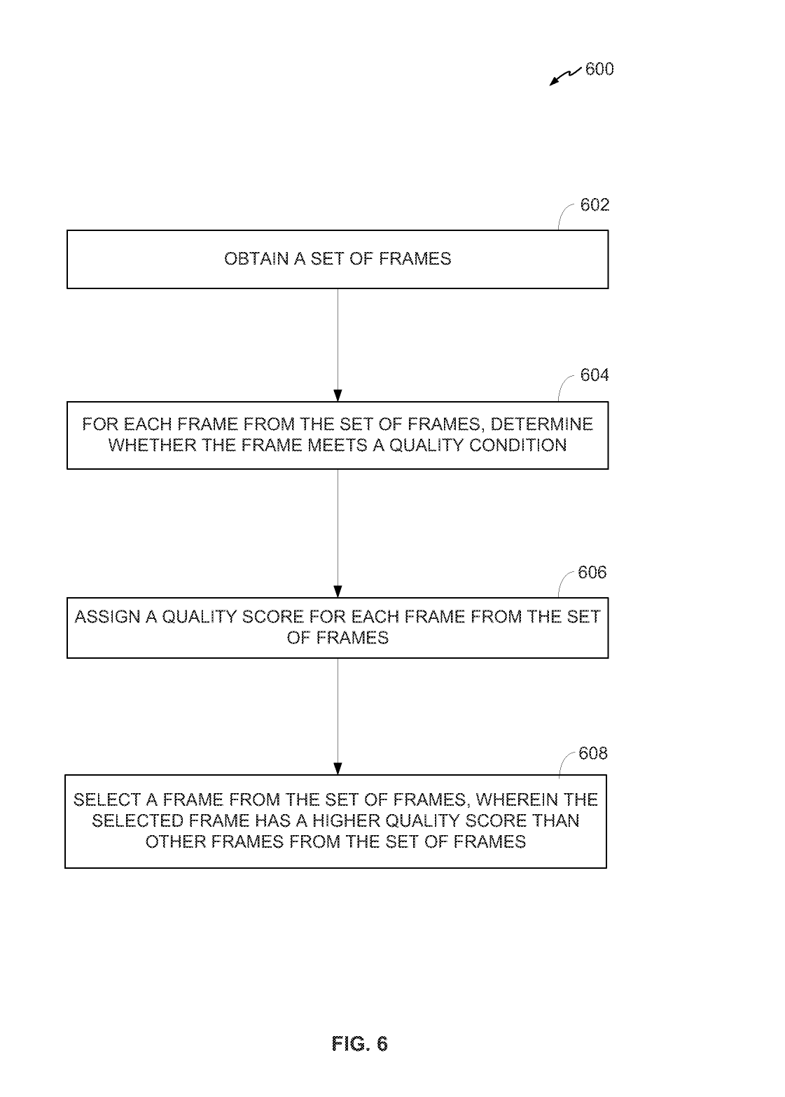

FIG. 6 is a flow diagram 600 of steps taken to implement a method for selecting a frame from a set of frames capturing the label of a product, used for determining authenticity of the product via an authentication service, according to an example. In discussing FIG. 6, reference may be made to FIGS. 1-4 and the components depicted in FIG. 5. Such reference is made to provide contextual examples and not to limit the manner in which the method depicted by FIG. 6 may be implemented.

At 602, a computing device, such as a smartphone, may obtain a set of frames, capturing the label of a product (e.g., label 100 of FIG. 1). As an example, the label may include graphical content, such as a QR code 102, and copy protection features 104 near and/or around the QR code 102.

At 604, for each frame from the set of frames, the smartphone may determine whether the frame meets a quality condition. As an example, the quality condition may be one or more of the metrics described above. One metric includes determining whether a number of pixels in the frame between symbols within the frame is greater than a specified number of pixels. Referring to FIG. 2, the computing device may determine whether the number of pixels between the QR calibration marks 202a-c is greater than the specified number of pixels.

Another metric includes calculating a sharpness score of an area of the frame defined by the symbols, and determining whether the sharpness score is above a threshold value. Referring to FIG. 3, the area of the frame for calculating the sharpness score may be defined as the area within a rectangle whose three corners are matched with the centroids of the QR calibrations marks 202a-c. As described above, the sharpness score may be based on a distribution of bitonal color values in the area of the frame.

Another metric includes measuring average luminous intensity absolute differences from several sets of regions within the frame. Referring to FIG. 4, in one implementation, such as a design including a QR code, the sets of regions may correspond to the four black bars around each QR calibration mark, which includes a horizontal pair and a vertical pair. If a maximum of the average luminous intensity absolute difference for the sets of regions is less than a threshold value, the frame may have sufficient luminance uniformity across the frame. In another implementation, corresponding to a design with a one-dimensional barcode, the analogous calculation may be determined using specific instances of single one-dimensional bars throughout the code.

At 606, the computing device may assign a quality score for each frame from the set of frames. As an example, the quality score for each frame may be based at least upon the number of pixels in the frame between the symbols, the sharpness score, and the maximum of the average luminous intensity absolute difference for the sets of regions within the frame. As described above, each metric may be weighted, and the quality score may be a weighted sum of the weighted metrics. Adjusting the weight given to each metric may change the quality score assigned to a particular frame.

At 608, the computing device may select a frame from the set of frames that has a higher quality score than other frames from the set of frames. As an example, the frame selected may meet the quality condition described above, by meeting one or more the metrics. However, rather than filtering out frames that do not meet these metrics, the frame having the highest quality score from all frames captured may be selected. As an example, all weights given to metrics other than the sharpness metric may be set to zero. As a result, the selected frame may have a higher sharpness score than other frames from the set of frames. As another example, the selected frame may have a higher sum of sharpness score plus resolution score than other frames from the set of frames.

Embodiments can be realized in any memory resource for use by or in connection with a processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” may be at least one machine-readable storage medium. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 6 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

1. A method comprising:
obtaining, by a computing device, a set of frames;
for each respective frame from the set of frames, determining, by the computing device, whether the respective frame meets a quality condition, the determining comprising determining whether a number of pixels in the respective frame between symbols within the respective frame is greater than a specified number of pixels;
assigning, by the computing device, a quality score for each frame from the set of frames; and
selecting, by the computing device, a frame from the set of frames, wherein the selected frame has a higher quality score than other frames from the set of frames.

2. The method of claim 1, wherein the frame selected from the set of frames meets the quality condition.

3. (canceled)

4. The method of claim 1, wherein the determining comprises:
calculating a sharpness score of an area of the respective frame, wherein the area is defined by the symbols; and
determining whether the sharpness score is above a threshold value.

5. The method of claim 4, wherein the sharpness score is based on a distribution of bitonal color values in the area of the respective frame.

6. The method of claim 4, wherein the selected frame has a higher sharpness score than other frames from the set of frames.

7. The method of claim 4, wherein the determining comprises:
measuring an average luminous intensity absolute difference for sets of regions within the respective frame; and
determining whether a maximum of the average luminous intensity absolute difference for the sets of regions is less than another threshold value.

8. The method of claim 7, wherein the quality score for each corresponding frame from the set of frames is based at least upon a weighted sum of the number of pixels in the corresponding frame between the symbols, the sharpness score, and the maximum of the average luminous intensity absolute difference for the sets of regions.

9. The method of claim 1, comprising:
sending the selected frame to an authentication service for authenticating a label captured in the selected frame.

10. (canceled)

11. A non-transitory memory resource comprising instructions that when executed cause a processing resource to:
obtain a set of frames including a barcode;
for each frame from the set of frames, determine whether the barcode in the frame meets a quality condition, wherein the instructions to determine for each frame from the set of frames comprise instructions to determine whether a number of pixels in the frame between symbols within the barcode is greater than a specified number of pixels;
assign a quality score for each frame from the set of frames; and
select a frame from the set of frames, wherein the selected frame meets the quality condition and has a higher quality score than other frames from the set of frames.

12. The non-transitory memory resource of claim 11, wherein the instructions to determine for each frame from the set of frames comprise instructions to:
calculate a sharpness score of an area of the barcode in the frame, wherein the area is defined by the symbols; and
determine whether the sharpness score is above a threshold value.

13. The non-transitory memory resource of claim 12, wherein the instructions to determine for each frame from the set of frames comprise instructions to:
measure an average luminous intensity absolute difference for sets of regions within the barcode; and
determine whether a maximum of the average luminous intensity absolute difference for the sets of regions is less than another threshold value.

14. A computing device comprising:
a processor; and
a non-transitory storage medium storing instructions executable on the processor to:
obtain a set of image frames including a barcode;
for each respective image frame from the set of image frames, determine whether the barcode in the respective image frame meets a quality condition, wherein the determining of whether the barcode in the respective image frame meets the quality condition comprises determining whether a number of pixels in the respective image frame between calibration marks of the barcode within the respective image frame is greater than a specified number of pixels;
assign a quality score for each image frame from the set of image frames;
select an image frame from the set of image frames, wherein the selected image frame meets the quality condition and has a higher quality score than other image frames from the set of image frames; and
send the selected image frame to an authentication service for authenticating a label captured in the selected image frame.

15. The computing device of claim 14, wherein the assigning of the quality score comprises:
calculating a sharpness score of an area of the barcode in each respective frame, wherein the area is defined by the calibration marks.

16. The method of claim 1, wherein the assigning of the quality score for a given frame from the set of frames is based on:
a sharpness score of an area of the given frame, the area defined between the symbols, and
an average luminous intensity absolute difference for regions within the given frame.

17. The method of claim 16, wherein the assigning of the quality score for the given frame is based on:
a weighted sum of the sharpness score and the average luminous intensity absolute difference.

18. The method of claim 16, wherein the assigning of the quality score for the given frame is further based on:
the number of pixels between the symbols.

19. The non-transitory memory resource of claim 11, wherein the assigning of the quality score for a given frame from the set of frames is based on:
a sharpness score of an area of the given frame, the area defined between the symbols,
the number of pixels between the symbols, and
an average luminous intensity absolute difference for regions within the given frame.

20. The non-transitory memory resource of claim 19, wherein the assigning of the quality score for the given frame is based on:
a weighted sum of the sharpness score, the number of pixels between the symbols, and the average luminous intensity absolute difference.

21. The non-transitory memory resource of claim 11, wherein the symbols comprise calibration marks of the barcode.

22. The computing device of claim 15, wherein the assigning of the quality score further comprises:
calculating an average luminous intensity absolute difference for regions within each respective image frame.
